(19) United States
(12) Patent Application Publication
(10) Pub. No.: US 2023/0399075 A1
(43) Pub. Date: Dec. 14, 2023

(54) A MECHANICAL REGENERATIVE BRAKING SYSTEM

(71) Applicant: Ravi Ganesh ATHALYE, Maharashtra (IN)

(72) Inventor: Ravi Ganesh ATHALYE, Maharashtra (IN)

(21) Appl. No.: 18/031,803

(22) PCT Filed: Dec. 15, 2020
(86) PCT No.: PCT/IN2020/051030

§ 371 Date: Apr. 13, 2023

(30) Foreign Application Priority Data
Oct. 15, 2020 (IN) 202021045007

(51) Int. Cl. B62M 1/10

(52) U.S. Cl. CPC B62M 1/105

(57) ABSTRACT

A regenerative braking system includes an epicyclic transmission unit to transfer braking energy through an arrangement of a sun gear and planetary gears to a torque storage module. In addition, the system includes a braking unit that arrests the rotation of planetary gears such that momentum available at the rear wheel hub is transferred to the sun gear. The sun gear is mounted on the outer casing and rotates a first pulley that charges a spring of the torque storage module. The spring discharges and transfers momentum to the rear wheel hub via the first pulley, the sun gear, a one-way cam bearing, and an extended hub on releasing the brake disc.

### FIELD OF THE INVENTION

The present invention relates to the field of regenerative braking systems.

### BACKGROUND OF THE INVENTION

A brake is applied in a bicycle to reduce its momentum. While applying brakes, brake pads apply frictional force either on a brake disc or on a rim of a wheel. During braking, the kinetic energy of the wheel is converted into heat which is lost in the atmosphere. Regenerative braking systems aim to reduce the loss of energy during braking. Various regenerative systems are known in the art. However, each one has had their own shortcomings. For example, one of the regenerative braking systems includes a brake lever connected to a roller wheel which upon the brake lever operation, clamps it on the rotating wheel threaded surface. The roller wheel is connected through a chain to the clock spring thereby coiling it against the spring bias. This system derives the roller wheel contact force with the outer surface of the rear wheel from the brake lever grip force. Whereas the grip force is sufficient for braking in disk brakes, it severely limits the force of the roller to the wheel thus limiting the level of torque transferred causing slippage of the roller on the wheel surface. During making of the contact of the roller with the wheel surface there occurs frictional losses that reduces the efficiency of the transfer.

There is an art that employs gears that enable the fixed spring to be coupled to the moving bicycle wheel in an attempt to reduce the frictional losses associated with the previous art. The stationery gear connected to the spring is made to mate with a rotating gear connected to bicycle hub. The art suffers from a shortcoming that the rider is required to match the speed of the gears involved by back pedaling which speeds up the gear connected to the spring before mating with the rotating gear connected to the wheel. Any mismatch leads to the gears grating and increasing transfer losses leading to loss of efficiency. The technique for speed matching is itself a barrier to its use.

Therefore, there is felt a need of a regenerative braking system that alleviates the aforementioned drawbacks of the conventional regenerative braking systems.

### SUMMARY

The present invention envisages a mechanical regenerative braking system. The braking system comprises an extended hub connected to a rear wheel hub of a vehicle, an epicyclic gear transmission unit, a braking unit, a first pulley, and a torque storage module. The extended hub has a one-way cam bearing mounted thereon. An outer casing is mounted on the one-way cam bearing. The epicyclic gear transmission unit has a sun gear, a plurality of planetary gears, a planetary gear mount and a ring gear. The ring gear is connected to the rear wheel hub. The sun gear is mounted on the outer casing over the one-way cam. The outer casing has a first bearing mounted thereon. The planetary gear mount is mounted on the first bearing. The planetary gear mount is configured to support the planetary gears.

The braking unit has a brake disc connected to the planetary gear mount and brake pads configured to arrest rotation of the brake disc on actuation.

The first pulley is mounted on the outer casing, and configured to rotate with the sun gear.

The torque storage module is coupled to the first pulley. The module has a spring coupled to the first pulley via a cord. The cord has a first end connected to the first pulley. The cord has a second end coupled to the torque storage module. The torque storage module has a shaft supported on a base. The shaft has a second pulley mounted thereon. The spring has a first end fixed to the base. The spring has a second end affixed to the second pulley. The second end of the cord is wrapped around said second pulley.

The spring is biased against the rotation of the first pulley on rotation of the sun gear in reverse direction to the rotation of the ring gear to store the momentum. The spring is configured to rotate the first pulley in the forward direction of rotation of the wheel to transfer stored momentum to the rear wheel through the sun gear, the outer casing, and the one-way cam the extended hub. The one-way cam securely connects the outer casing to extended hub provided the outer casing is rotating faster than the extended hub. Once the outer casing becomes slower in rotating as compared to the extended hub than the extended hub freely rotates without the constraints of the outer casing.

### BRIEF DESCRIPTION OF THE ACCOMPANYING DRAWINGS

The invention will now be described in greater detail with reference to an embodiment which is illustrated in the drawing figures:

FIG. 1 illustrates a schematic view of a bicycle depicting a mechanical regenerative braking system mounted thereon;

FIG. 2 illustrates an isometric view of the mechanical regenerative braking system;

FIG. 3 illustrates an exploded view of the mechanical regenerative braking system;

FIG. 4 illustrates a sectional view of the mechanical regenerative braking system;

FIG. 5 illustrates an isometric view of a torque storage module of the mechanical regenerative braking system; and

FIG. 6 illustrates an isometric view of a first pulley of the mechanical regenerative braking system.

### DETAILED DESCRIPTION OF THE INVENTION

The foregoing objectives of the present invention are accomplished, and the problems and shortcomings associated with the prior art, techniques and approaches are overcome by the present invention as described below in the preferred embodiments.

Although specific terms are used in the following description for sake of clarity, these terms are intended to refer only to particular structure of the invention selected for illustration in the drawings and are not intended to define or limit the scope of the invention. References in the specification to “preferred embodiment” means that a particular feature, structure, characteristic or function described in detail thereby omitting known constructions and functions for clear description of the present invention.

The following description with reference to the accompanying drawings is provided to assist in a comprehensive understanding of exemplary embodiments of the invention. It includes various specific details to assist in that understanding but these are to be regarded as merely exemplary. Accordingly, those of ordinary skill in the art will recognize that various changes and modifications of the embodiments described herein can be made without departing from the scope of the invention.

In general aspect, the present invention provides a mechanical regenerative braking system (hereinafter also referred to as ‘system’). The system employs a gear mechanism to utilize momentum of a wheel after braking which is stored in a spring-based torque module and supplied back to the wheel when braking force is removed.

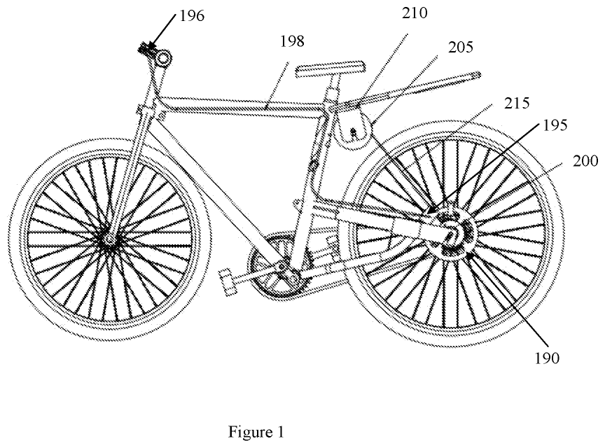

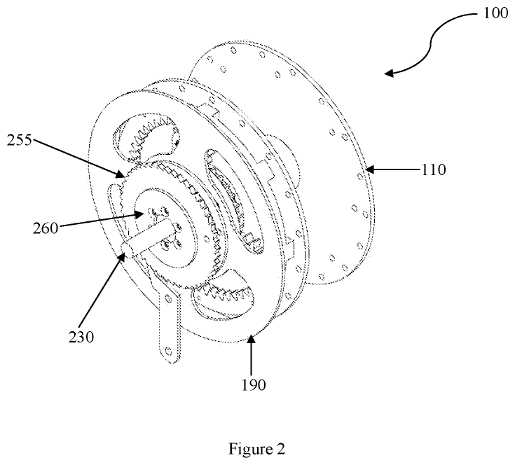

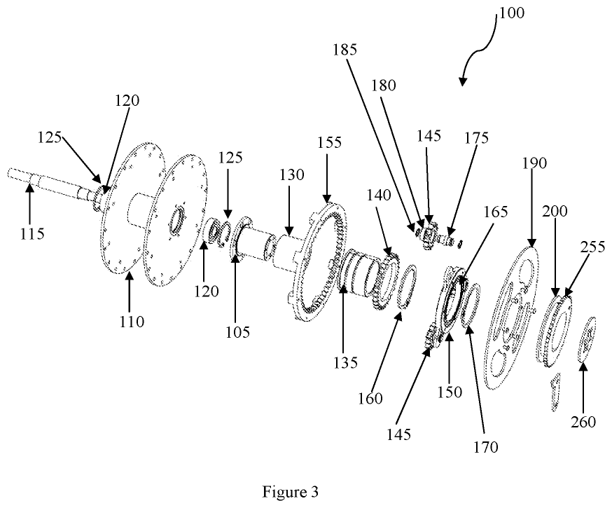

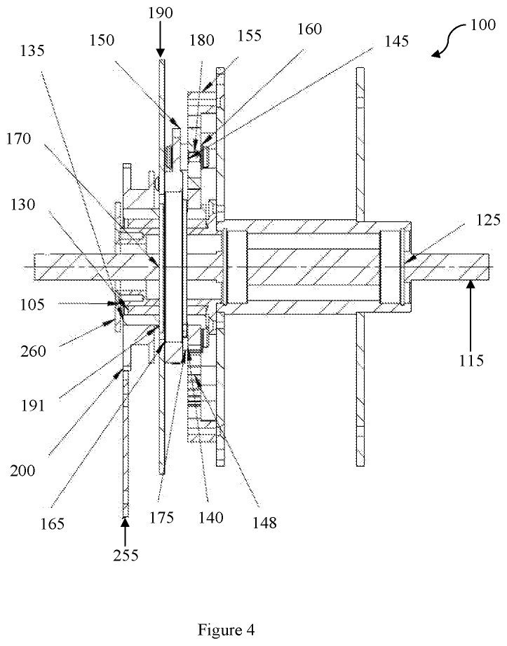

The system is now described in detail with reference to accompanying FIGS. 1 to 6. It is to be noted that although the system is shown mounted on a bicycle, the system can be employed onto any other vehicle. In the specification and claims, the term ‘forward direction’ refers to direction of forward movement of the vehicle, and the term ‘reverse direction’ refers to direction opposite to the forward movement of the vehicle.

Referring to FIGS. 1-4, a system 100 constructed in accordance with the present invention is shown. The system 100 comprises an extended hub 105 mounted over a conventional rear wheel hub 110 of a vehicle. In this one embodiment, the rear wheel hub 110 is illustrated as a conventional hub of a bicycle. However, it is understood that the extended hub 105 can be connected to a rear wheel hub of any other vehicle in other alternative embodiments of the present invention. The rear wheel hub 110 has two circular flanges having holes thereon to facilitate engagement of spokes of the rear wheel of the vehicle with the rear wheel hub 110. The rear wheel hub 110 has a central opening to receive a shaft 115 therethrough. The rear wheel hub 110 is mounted on the shaft 115 via a pair of bearings 120 positioned therebetween. The bearings 120 are secured on the shaft 115 using circlips 125. The rear wheel hub 110 has a first side that is connected to a chain and sprocket arrangement of the vehicle. The rear wheel hub 110 has a second side that is connected to the extended hub 105 using connectors such that the longitudinal axis of the extended hub 105 and that of the rear wheel hub 110 are aligned. Thus, the extended hub 105 is connected to the rear wheel hub 110 on the opposite side of the chain and sprocket arrangement. The system 100 comprises a one-way cam bearing 130 mounted on the extended hub 105. The system 100 comprises an outer casing 135 mounted on the one-way cam bearing 130. The system 100 comprises an epicyclic gear transmission unit. The gear transmission unit has a sun gear 140, a plurality of planetary gears 145, a planetary gear mount 150, and a ring gear 155. The ring gear 155 is connected to the rear wheel hub 110 such that the ring gear 155 rotates with the rear wheel hub 110. The sun gear 140 is mounted on the outer casing 135. The sun gear 140 is secured on the outer casing 135 using a first circlip 160. The sun gear 140 can rotate the extended hub 105 in only one direction, i.e., only in forward direction of rotation of the vehicle as the outer casing 135 is mounted on the one-way cam bearing 130 which is mounted on the extended hub 105. When the sun gear 140 is rotating in reverse or backward direction of rotation, the sun gear 140 and the outer casing 135 freely rotates on the extended hub 105 without transmitting any rotational movement onto the extended hub 105 due to the one-way cam bearing 130.

A first bearing 165 is mounted on the outer casing 135 and secured using a second circlip 170. The planetary gear mount 150 is mounted on the first bearing 165. The planetary gear mount 150 freely rotates on the outer casing 135 due to the first bearing 165.

The planetary gear mount 150 is configured to support the planetary gears 145 thereon. The planetary gear mount 150 has a plurality of arms to support the planetary gears 145. In an embodiment, the planetary gear mount 150 has three arms to support three planetary gears. The arms have holes to receive a planetary gear shaft 175. Each planetary gear 145 is mounted on the planetary gear shaft 175 via a second bearing 180. In an embodiment, the second bearing 180 is a bush bearing. Due to the second bearing 180, the planetary gears 145 freely rotates on respective planetary gear shafts 175. The planetary gear 145 is secured on the planetary gear shaft 175 using a pair of third circlips 185. The planetary gears 145 mesh with the sun gear 140 and the ring gear 155.

The system 100 comprises a braking unit configured to arrest the rotation of the rear wheel of the vehicle. The braking unit has a brake disc 190 and brake pads 195. The brake disc 190 is connected to the planetary gear mount 150 via fasteners 191. The brake disc 190 rotates with the planetary gear mount 150. In normal operation, the planetary gear mount 150 rotates with the ring gear 155 such that the brake disc 190 also rotates in same direction as that of the ring gear 155 and the rear wheel hub 110.

The brake pads 195 are mounted on one of the rear forks of the vehicle. The brake pads 195 are configured to arrest the rotation of the brake disc 190 due to frictional force. The brake pads 195 are actuated by a lever 196 of a hand brake. The lever 196 is coupled to the brake pads 195 via a cable 198. The brake pads 195 embrace the brake disc 190 upon actuation by the lever 196.

The system 100 comprises a first pulley 200 mounted on the outer casing 135. The first pulley 200 rotates with the sun gear 140. The planetary gear mount 150 stops rotating upon arresting the rotation of brake disc 190 which allows the planetary gears 145 to rotate the sun gear 140 in reverse direction to that of the ring gear 155 that further allows the first pulley 200 to rotate in reverse direction to that of the ring gear 155 along with the sun gear 140. Accordingly, the planetary gears 145 transmit momentum of the ring gear 155 to the first pulley 200 by rotating the sun gear 140 in a direction opposite to the direction of rotation of the ring gear 155 on arrested motion of the brake disc 190 and the planetary gear mount 150.

The system 100 comprises a torque storage module 205 coupled to the first pulley 200. The torque storage module 205 is configured to store momentum transferred by the planetary gears 145 to the first pulley 200 and provides the stored momentum back to the first pulley 200 upon removal of braking force by release of the brake lever by the vehicle rider. The torque storage module 205 is arranged on the vehicle in a spaced apart configuration. For example, in case of a bicycle, the torque storage module 205 is arranged below the seat of the bicycle using a support 210. However, it is understood that the configuration and position of the torque storage module 205 may vary in various other alternative embodiments of the present invention.

The torque storage module 205 is coupled to the first pulley 200 via a cord 215. The cord 215 has a first end that is connected to the first pulley 200. The cord 215 has a second end that is coupled to the torque storage module. The module 205 comprises a spring 220 coupled to the first pulley 200 via the cord 215. The spring 220 is biased against the rotation of the first pulley 200, on rotation of the sun gear 140 in reverse direction to the rotation of the ring gear 155, to store the momentum in the spring 220. The spring 220 is configured to rotate the first pulley 200 in forward direction of rotation of the rear wheel to transfer stored momentum to the rear wheel hub 110 through the sun gear 140, the outer casing 135, the one-way cam bearing, the extended hub 105 on releasing the brake disc 190. Once the outer casing 135 becomes slower in rotating as compared to the extended hub 105, the extended hub 105 freely rotates without the constraints of the outer casing 135.

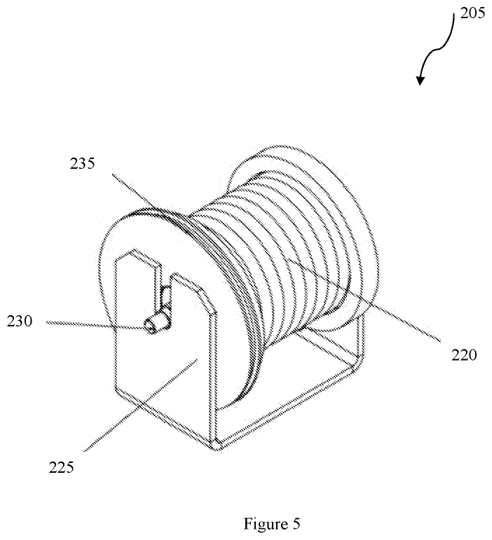

As shown in FIG. 5, in an embodiment, the torque storage module 205 includes a base 225, a shaft 230 resting on the base 225, a second pulley 235 mounted on the shaft 230. The spring 220 has a first end that is fixed to the base 225. The spring 220 has a second end that is affixed to the second pulley 235. The second end of the cord 215 is wrapped around the second pulley 235. The spring 220 is configured to rotate against the spring bias upon rotation of the first pulley 200 with the sun gear 140 in reverse direction to the rear wheel hub 110 of the vehicle in order to store the momentum of the ring gear 155. The cord 215 is connected to the first pulley 200 and wrapped around the second pulley 235 such that when the first pulley 200 rotates in reverse direction to the rear wheel hub 110, the cord 215 is wrapped onto the first pulley 200 and is unwrapped from the second pulley 235.

In an embodiment, the second end of the spring 220 affixed to the second pulley 235 rotates by one turn at maximum braking force applied on the brake disc 190.

In an embodiment, the spring 220 is a torsion spring. In another embodiment, the spring 220 is a helical spring.

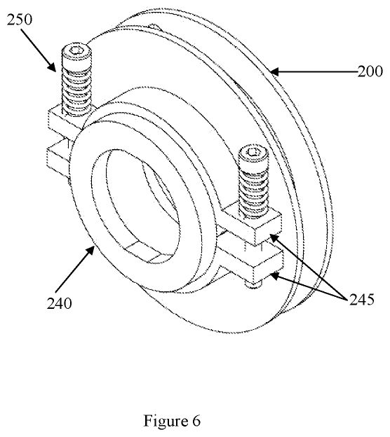

To prevent excessive reverse rotation of the first pulley 200, a threshold mechanism is employed in the first pulley 200. Referring to FIG. 6, the first pulley 200 has an axial extension 240 having circumferential holes. A plurality of ball bearings is disposed in the holes. The ball bearings rest on indentations configured on the outer casing 135. The extension 240 is surrounded with a pair of semi-circular plates 245 clamped to each other using a spring-loaded screw arrangement 250. The threshold torque on the first pulley 200 is determined by altering the distance between the pair of plates 245 using the spring-loaded screw arrangement 250. In normal operation, the ball bearings rests in the indentations and the first pulley 200 rotates as per the torque received from the sun gear 140. In case of reverse rotation of the sun gear 140, if the torque on the first pulley 200 exceeds the predetermined threshold torque, the balls slip from the indentations, and the first pulley 200 stops rotating further. This reduces the risk of excessive loading on the spring 220 and prevents spring 220 from damage. The predetermined threshold torque on the first pulley 200 can be adjusted by altering the distance between the plates 245 using the spring-loaded screw arrangement 250.

In an embodiment, the system 100 includes a ratchet and pawl mechanism 255 connected to the first pulley 200. The ratchet and pawl mechanism 255 selectively arrests rotation of the first pulley 200 in the forward direction of rotation of the rear wheel. In particular, the ratchet and pawl mechanism 255 controls the transfer of momentum from the spring 220 to the first pulley 200. The ratchet and pawl mechanism 255 is configured to be operated by a lever connected to the pawl via a cable. When a rider wants to utilize the momentum stored in the spring 220, he/she operates the lever to unlock the ratchet from the pawl, thereby allowing the ratchet and the first pulley 200 to rotate in forward direction of rotation of the rear wheel.

The system 100 includes an end stopper 260 mounted on the outer casing 135 to secure the pawl and ratchet mechanism 255 and all other components on the outer casing 135.

The operational working the system 100 is described hereinafter. In operation, the system 100 utilizes the momentum of bicycle in forward motion thereof when brakes are applied. When the rotation of the brake disc 190 is arrested, the planetary gears 145 reverse the rotation of the sun gear 140.

In operation, to apply brakes, a rider presses the lever 196 to allow embracing of the brake pads 195 to the brake disc 190. This arrests the rotation of the brake disc 190. As the brake disc 190 is connected to the planetary gear mount 150, the rotational motion of the planetary gear mount 150 is also arrested. However, at this stage, the ring gear 155 still rotates in the forward direction thereby allowing the sun gear 140 to rotate in reverse direction due to arrangement of the planetary gears 145. The first pulley 200 also rotates in reverse direction as that of the sun gear 140 since both are mounted on same outer casing 135 such that the cord 215 is wrapped onto the first pulley 200, thereby biasing the spring 220. Accordingly, the ring gear 155 transfers the momentum to the spring 220. It is understood here that when the first pulley 200 is rotated in reverse direction to its extreme capacity, the further reverse rotation of the sun gear 140 is prevented thereby locking the rotation of the planetary gears 145. This prevents any further rotation of the ring gear 155 and the rear wheel hub 110. In this manner, the rear wheel stops rotating, and the brakes are said to be applied. It is understood the rider can partially release the brake lever 196 to achieve a desired coasting of the bicycle.

In operation, the first pulley 200 is free from the constraints of the planetary gears 145 upon releasing the braking force on the brake disc 190 by the lever 196. The biased spring 220 returns to its unbiased state. This causes the cord 215 to wrap onto the second pulley 235 and unwrap from the first pulley 200. The unwrapping of the cord 215 from the first pulley 200 results in rotating the first pulley 200 in forward direction. This causes the sun gear 140 to rotate in the forward direction. The sun gear gets engaged with the extended hub 105 through the one-way cam bearing 130 and the extended hub 105 rotates in forward direction. As the extended hub 105 is connected with the rear wheel hub 110, the rear wheel hub 110 and the rear wheel also rotates. In this manner, the stored momentum/energy of the spring 220 is transferred to the rear wheel. This occurs only if the ring gear 155 is rotating slower than the sun gear 140. Once the sun gear 140 is slower than the ring gear 155, the rear wheel is free to be used like a conventional bicycle under the influence of the pedal gear connection to the rear wheel. As the bicycle accelerates due to the torque generated by the spring 220, the spring 220 returns to its base unbiased state. The first pulley 200 slows and stops rotating as the spring 220 returns to the base state. This causes the sun gear 140 to slow down and stop while the extended hub 105 freely rotates with respect to the sun gear 140, and the ring gear 155 and the rear wheel hub 110 continues its travel in the forward direction. The sun gear 140 has restrictions on rotation in forward direction due to constraints of the cord 215 and the spring 220 on the first pulley 200.

The working of the system 100 in foregoing paragraphs is explained with reference to the system 100 without the ratchet and pawl mechanism. In an embodiment, wherein the system 100 includes the ratchet and pawl mechanism 255, the rider has to press the lever to release the first pulley 200 from the constraints of the ratchet and pawl mechanism 255 to utilize the stored momentum in the spring 220.

The system, of the present invention, eliminates the limitation of maximum torque transfer and frictional loss with respect to the spring. The system 100 also eliminates the need for the rider to master the technique of synchro meshing the gears.

The foregoing description of specific embodiments of the present invention has been presented for purposes of illustration and description. They are not intended to be exhaustive or to limit the present invention to the precise forms disclosed, and obviously many modifications and variations are possible in light of the above description.

The embodiments were chosen and described in order to best explain the principles of the present invention and its practical application, to thereby enable others, skilled in the art to best utilize the present invention and various embodiments with various modifications as are suited to the particular use contemplated.

It is understood that various omission and substitutions of equivalents are contemplated as circumstance may suggest or render expedient, but such are intended to cover the application or implementation without departing from the spirit or scope of the present invention.

Figures are merely representational and are not drawn to scale. Certain portions thereof may be exaggerated, while others may be minimized. Figures illustrate various embodiments of the invention that can be understood and appropriately carried out by those of ordinary skill in the art.

1.-15. (canceled)

16. A mechanical regenerative braking system comprising:
an extended hub connected to a rear wheel hub of a vehicle, said extended hub having a one-way cam bearing mounted thereon, said one-way cam bearing having an outer casing mounted thereon;
an epicyclic gear transmission unit having a sun gear, a plurality of planetary gears, a planetary gear mount and a ring gear, said ring gear connected to said rear wheel hub, said sun gear mounted on said outer casing, said outer casing having a first bearing mounted thereon, said planetary gear mount mounted on said first bearing, said planetary gear mount having the planetary gears supported thereon;
a braking unit having a brake disc and brake pads, said brake disc connected to said planetary gear mount;
a first pulley mounted on said outer casing, said first pulley configured to rotate with said sun gear; and
a torque storage module coupled to said first pulley, said module having a spring coupled to said first pulley via a cord, said cord having a first end connected to said first pulley, said cord having a second end coupled to said torque storage module, said torque storage module having a shaft supported on a base, said shaft having a second pulley mounted thereon, said spring having a first end fixed to said base, said spring having a second end affixed to said second pulley, and the second end of said cord wrapped around said second pulley.

17. The mechanical regenerative braking system as claimed in claim 16, wherein said planetary gears are configured to mesh with said sun gear and said ring gear.

18. The mechanical regenerative braking system as claimed in claim 16, wherein said brake pads are configured to arrest rotation of the brake disc upon actuation by a lever of a hand brake.

19. The mechanical regenerative braking system as claimed in claim 16, wherein said planetary gears are configured to transmit momentum of said ring gear to said first pulley by rotating said sun gear n a direction opposite to a direction of the rotation of said ring gear on arrested motion of said brake disc and said planetary gear mount.

20. The mechanical regenerative braking system as claimed in claim 16, wherein said spring is biased against the rotation of said first pulley on rotation of said sun gear in reverse direction to the rotation of said ring gear to store the momentum therein.

21. The mechanical regenerative braking system as claimed in claim 16, wherein said spring is configured to rotate said first pulley in a forward direction of rotation of said rear wheel to transfer stored momentum to said rear wheel hub through said sun gear, said outer casing, said one-way cam bearing, and said extended hub upon releasing said brake disc.

22. The mechanical regenerative braking system as claimed in claim 16, wherein said first pulley has a ratchet and pawl mechanism connected to said first pulley to selectively arrest rotation of said first pulley in the forward direction of rotation of said rear wheel.

23. The mechanical regenerative braking system as claimed in claim 22, wherein said ratchet and pawl mechanism is actuated by a lever connected to a pawl of said ratchet and pawl mechanism via a cable.

24. The mechanical regenerative braking system as claimed in claim 16, wherein said spring is a torsion spring or a helical spring.

25. The mechanical regenerative braking system as claimed in claim 16, said second end of said spring affixed to said second pulley rotates by one turn at maximum braking force applied on said brake disc.

26. The mechanical regenerative braking system as claimed in claim 16, wherein said sun gear is secured on said outer casing using a first circlip.

27. The mechanical regenerative braking system as claimed in claim 16, wherein said planetary gear mount is secured on said outer casing using a second circlip.

28. The mechanical regenerative braking system as claimed in claim 16, wherein said first pulley has an extension, said extension has circumferential holes, a plurality of ball bearings are disposed in said holes, and said extension is surrounded with a pair of semi-circular plates clamped to each other.

29. The mechanical regenerative braking system as claimed in claim 28, wherein said ball bearings rest on indentations configured on said outer casing.

30. The mechanical regenerative braking system as claimed in claim 28, wherein said plates are clamped to each other using a spring screw arrangement.
